(19) United States
(12) Patent Application Publication
(10) Pub. No.: US 2013/0283792 A1
(43) Pub. Date: Oct. 31, 2013

(54) Device and Method for Energy Supply for a Thermal Power Station System for a Building or a Vessel

(71) Applicant: Harald Nes Risla, Lillesand (NO)

(72) Inventor: Harald Nes Risla, Lillesand (NO)

(73) Assignee: VIKING HEAT ENGINES AS, Kristiansand (NO)

(21) Appl. No.: 13/991,117

(22) PCT Filed: Feb. 16, 2011
(86) PCT No.: PCT/NO2011/000054

§ 371 Date: Jul. 22, 2013

(30) Foreign Application Priority Data
Dec. 10, 2010 (NO) 20101725

(51) Int. Cl. F03G 7/04; F03G 6/00; F01K 7/00

(52) U.S. Cl. CPC F03G 7/04; F01K 7/00; F03G 6/00
USPC 60/641.2; 60/508; 60/645; 60/641.8

(57) ABSTRACT

A thermal power station system has at least one heat engine connected to at least one work receiver. The heat engine is arranged to be able to utilize a working fluid alternating between liquid and gas phase. In the heat engine is arranged at least one heat exchanger in thermal contact with at least one expansion chamber. A method is for energy supply to a building or a vessel.

There is described a thermal power station system wherein at least one heat engine is connected to at least one work receiver. Also described is a method for energy supply to a building or a vessel.

Thermal power stations have lately become more and more relevant, as it often turns out to be favourable to produce electric power in addition to heat from a heat source. The terms CHP (Combined Heat and Power) and μCHP (micro-CHP) are used for thermal power stations. In the following the term CHP is used for any form of thermal power station.

The CHP system produces both electric power and thermal energy (heat) from several different heat sources. Heat sources may i.a. be sun, fuels and geothermal wells. Fuels may be oil, gas, wood, wood chips, straw, wood pellets, refuse, alcohols etc. To produce electric power in CHP systems a heat energy engine, or more generally also called a heat engine, is most often used. A heat engine is a device that converts heat energy to mechanical energy, which in turn may be converted to electrical power by means of a generator. Previously several systems for CHP are known. Examples of modern CHP systems are i.a. illustrated in US 2010/0244444 A1 and WO 2007/082640.

The advantage of CHP is that a high energy utilisation of the heat may be achieved, as the waste heat left after some of the energy is converted to electricity may be used directly for heating, achieving a very high total efficiency in the system.

The object of the invention is to remedy or reduce at least one of the disadvantages of the prior art, or at least to provide a useful alternative to the prior art.

The object is achieved by the features disclosed in the below description and in the subsequent claims.

In connection with implementation of CHP systems several special considerations have to be made, as the systems are often to be operated in connection with buildings or vessels, such as dwellings or boats. Such considerations may be that the costs have to be minimised, that the size of the CHP plants must be minimized due to space limitations, the reliability must be high, exhaust must be diverted in a safe manner, components with high temperature must be made inaccessible so that humans or animals cannot be hurt etc. Due to such considerations there will often be a need to implement special measures ordinarily not necessary in corresponding technology installed in other contexts.

Measures extra favourable to implement are to ensure that the technology is as cheap as possible, that maintenance is as simple as possible, that operational reliability is as high as possible and that space and weight are small. As CHP systems utilise heat engines to produce electricity, it will be natural to focus on special measures to ensure that the heat engines have just these properties.

In current practice there are only a few heat engine technologies utilised for CHP systems. The most common are Stirling engines, ORC engines and redesigned Otto engines (petrol engines) utilising such as natural gas instead of petrol. All have various advantages and drawbacks, but some common denominators for the existing technologies are that they are often expensive and require advanced maintenance.

Stirling engines often work at very high working pressures, making the mechanical loads large, again hitting cost, reliability and the maintenance situation. ORC machines often utilise turbines as expansion mechanisms, and these are very expensive, in addition to requiring an evaporator, a component taking up much space. Rebuilt Otto engines are expensive, require relatively advanced maintenance i.a. due to their internal combustion, and they cannot utilise other heat sources than fuels suited for just internal combustion.

As an improved alternative to these technologies a piston based two-phase heat engine with at least one internal heat exchanger in at least one expansion volume will be able to be utilised. A two-phase heat engine is characterised in that it utilises a fluid alternating between a liquid and a gas phase.

Two-phase heat engines have the advantage of achieving relatively high power density even at lower pressures, as the phase transition from liquid to gas may give a high expansion ratio, at the same time as it requires relatively little energy to pump a fluid in liquid form prior to the expansion, as opposed to a heat engine where only a gas is utilised. The power density of a heat engine is often defined as energy output per machine volume unit or energy output per machine mass unit. By utilising a two-phase heat engine having an internal heat exchanger in the expansion volume, extra heat may be supplied during the expansion, like in a Stirling engine, leading to increased power density, which may contribute to further reducing the size of the engine. An ORC has only adiabatic expansion, i.e. expansion without heat supply, and will not be able to benefit from this advantage. For expanders the piston principle is the simplest and cheapest alternative. Moreover most engines produced today are piston engines, making production of piston baaed engines based on very available technology. This has a positive effect on i.a. cost and maintenance.

By utilising 2-phase piston based heat engines having internal heat exchangers in the expansion volumes, improving current CHP systems regarding cost, size, weight, reliability and maintenance is possible.

In a first aspect the invention relates more particularly to a thermal power station system wherein at least one heat engine is connected to at least one work receiver, characterised in that the heat engine is arranged to be able to utilise an operating fluid alternating between liquid and gas phase, and there in the heat engine is arranged at least one heat exchanger in thermal contact with at least one expansion chamber.

The work receiver may be a generator. The work receiver may alternatively be a shaft.

In a second aspect the invention relates more particularly to a method for power supply to a building or a vessel, characterised in that the method comprises the following steps:
to provide in or at the building or vessel a thermal power station system comprising at least one heat engine arranged to be able to utilise a working fluid alternating between liquid and gas phase, being arranged in the heat engine at least one heat exchanger in thermal contact with at least one expansion chamber;
to connect the at least one heat engine to one or more work receivers;
to transfer mechanical energy from the at least one heat engine to at least one of one or more work receivers; and
to transfer thermal energy from the thermal power station system to the building or the vessel.

In the following is described an example of a preferred embodiment illustrated in the accompanying drawings, wherein:

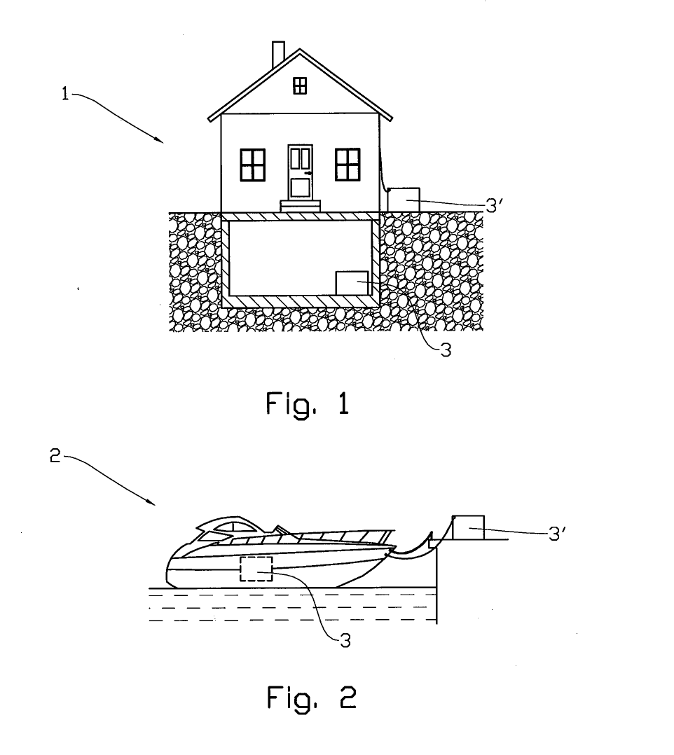

FIG. 1 shows schematically a CHP system installed in or connected to a building, in this example a dwelling partly sectioned;

FIG. 2 shows schematically a CHP system installed in or connected to a vessel, in this example a boat;

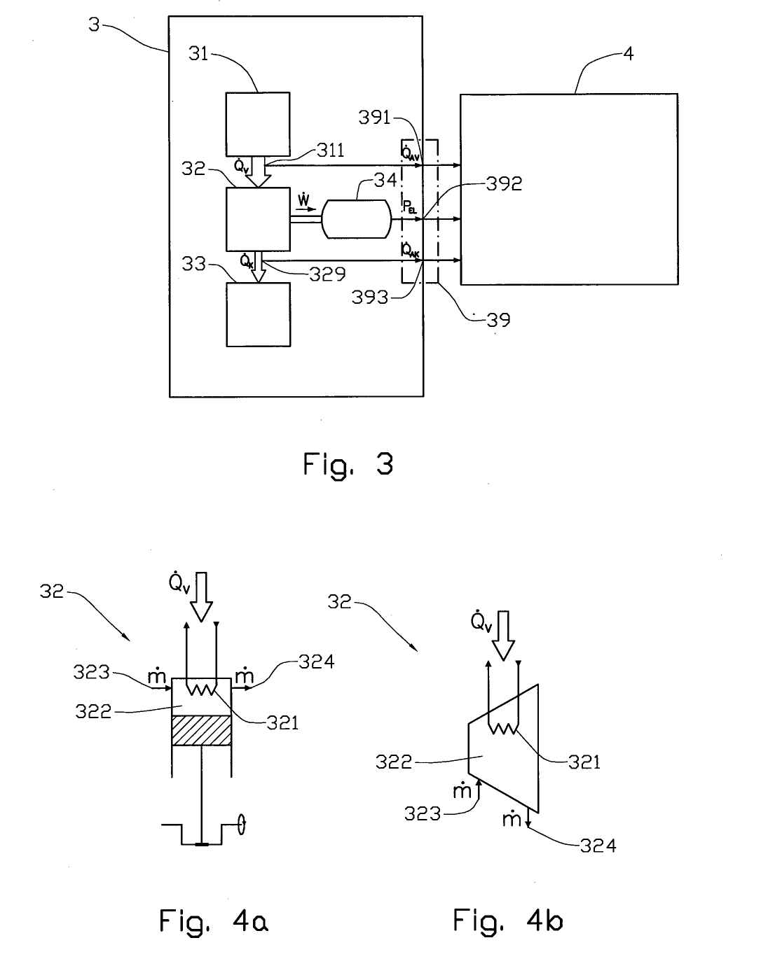

FIG. 3 shows schematically basic components in a CHP system and its possible connections to end users, which may be defined as any unit using energy produced by the CHP system; and

FIGS. 4a and b show examples of expansion arrangements for a heat engine having a heat exchanger in the expansion chamber.

In FIG. 1 the reference numeral 1 indicates a building wherein is arranged a thermal power station system 3 in a basement. An alternative position for the thermal power station system is indicated with the reference numeral 3′, here indicated outside the building 1.

In FIG. 2 is shown a vessel wherein the thermal power station system 3 is placed internally in the vessel. There is also indicated an alternative positioning of the thermal power station system 3′, here arranged in the immediate vicinity of the vessel 2 storage yard.

Reference is then made to FIG. 3. The thermal power station system 3 is here shown schematically. The thermal power station system 3 is via a multi power outlet 39 connected to a power consumer 4. A heat source 31 is in thermal connection with a heat engine 32 in turn thermally connected to a cold source 33. The heat source 31 delivers an amount of energy Qᵥ to the heat engine 32. From the heat flow Qᵥ between the heat source 31 and the heat engine 32 there may by means of a heat outlet point 311 be delivered high-grade heat energy Qₐᵥ to power end user 4 via a heat source outlet 391.

The heat engine 32 is connected to a work, receiver 34, typically a generator, and from this there may via a power outlet 392, typically an el-power outlet, be delivered energy P_{EL} to the power end user 4.

From a residual heat flow Q_{K} between the heat engine and the cold source 33 there may by means of a waste heat tapping point 329 be delivered residual heat energy Q_{AK} to the energy end user 4 via a waste heat outlet 393.

The heat source heat outlet 391, the el-power outlet 392 and the waste heat energy outlet 393 together form the multi energy outlet 39. The multi energy outlet 39 forms a practical interface between the thermal power station system and a distribution network (not shown) at the energy end user, for example distribution of electrical power for heating and light and also heat energy for room heating etc.

In FIG. 4 is shown examples of the heat engine 32 expansion chamber 322 and the appurtenant heat exchanger 321 where an energy amount Qᵥ is supplied. A working fluid with a flow rate m flows into the expansion chamber 322 through a working fluid inlet 323 and with the same flow rate m out from the expansion chamber 322 through a working fluid outlet 324.

The thermal power station system 3 is positioned in the building 1 or in the vessel 2 where there is a need for energy supply Q_{AV}, P_{EL}, Q_{AK} to one or more energy end users 4. The heat source 31 procures high-grade heat energy Q_{V} to the heat, engine 32 for example by burning wood chippings, wood pellets, oil or gas, heat recovery from ventilation air and other waste heat sources, process water etc. A share of the heat energy Q_{V}, may, if needed, be used in tapping from the heat tapping point 311 for use in end user(s) 4 in the need of high grade energy to function efficiently.

The heat engine 32 converts a portion of the supplied heat energy Q_{V} to mechanical energy by the working fluid m in a per se known way expanding in the expansion chamber 322 due to the heating. The expansion provides, possibly by means of transforming a translation movement to rotation, operation of the work receiver 34, which in a preferred embodiment is a generator able to produce electric power, which via the el-power outlet 392 may be distributed in a distribution network (not shown) at the end user 4.

When needed a portion of the residual heat Q_{K} normally being transferred from the heat engine 32 to the cold source 33, may be distributed via the waste heat outlet 393 to the end user 4 where recipients (not shown) able to utilise low-grade energy, make use of this waste heat in an appropriate manner, such as for heating. If the heating demand at the end user 4 is large enough, all of the waste heat Q_{K} may be distributed from the heat engine 32 to the end user 4, and consequently the cold source 33 will not have to receive any of this. In a further example where the end user 4 guaranteed will be able to use all the waste neat Q_{K} from the heat engine 32, the function of the independent cold source 33 may then be constituted by the end user 4, so that this will also have the function of cold source 33.

1. A thermal power station system comprising at least one heat engine connected to at least one work receiver, wherein the heat engine is arranged for receiving heat from at least one heat source and deliver residual heat to at least one cold source, wherein the heat engine is arranged to be able to utilise a working fluid alternating between liquid and gas phase, and wherein at least one heat exchanger is arranged in the heat engine in thermal contact with at least one expansion chamber.

2. A thermal power station system according to claim 1, wherein at least one working fluid inlet is connected to at least one expansion chamber.

3. A thermal power station system according to claim 1, wherein a working fluid outlet is connected to at least one expansion chamber.

4. A thermal power station system according to claim 1, wherein the thermal power station system is connected to an energy user via at least one of a heat source outlet, an el-power outlet and a waste heat outlet.

5. A thermal power station system according to claim 4, wherein the energy user is arranged for receiving a portion of at least one of the residual heat and the heat source heat Q_{AV} from the thermal power station system via a heat tapping point.

6. A thermal power station system according to claim 4, wherein the energy user is arranged for receiving all of the residual heat by scaling the consumption capacity large enough.

7. A thermal power station system according to claim 6, wherein the energy user is arranged for using all of the waste energy for heating.

8. A thermal power station system according to claim 1, wherein the heat source is a fuel burner.

9. A thermal power station system according to claim 8, wherein the heat source in the form of a fuel burner is arranged for burning one or more of the fuels picked from the group consisting of wood, wood chippings, an alcohol like ethanol or methanol, an ether like diethylether or dimethylether, a bio fuel like bio ethanol or bio diesel, a petroleum product like oil or gas, or refuses.

10. A thermal power station system according to claim 1, wherein the heat source is a thermal solar collector.

11. A thermal power station system according to claim 1, wherein the heat source is a geothermal heat source.

12. A thermal power station system according to claim 1, wherein the heat source is a waste heat source.

13. A thermal power station system according to claim 1, wherein the work receiver is a generator.

14. A thermal power station system according to claim 1, wherein the work receiver is a shaft.

15. A method for energy supply to a building or a vessel, wherein the method comprises:
providing in or at the building or vessel a thermal power station system comprising at least one heat engine arranged to be able to utilise a working fluid alternating between liquid and gas phase, in the heat engine being arranged at least one heat exchanger in thermal contact with at least one expansion chamber, and wherein the heat engine is arranged for receiving heat from at least one heat source and supply residual heat to at least one cold source;
connecting the at least one heat engine to at least one or more work receivers;
transferring mechanical energy from the at least one heat engine to at least one of one or more work receivers; and
transferring thermal energy from the thermal power station system to at least one of the building and the vessel.

16. A method according to claim 15, wherein the working fluid is injected into at least one expansion chamber in the heat engine via at least one working fluid inlet and further being expanded in the at least one expansion chamber, during the expansion also supplying heat to the working fluid front the at least one heat exchanger being in thermal contact with the at least one expansion chamber.
